(19) United States
(12) Patent Application Publication
(10) Pub. No.: US 2018/0374237 A1
(43) Pub. Date: Dec. 27, 2018

(54) METHOD, SYSTEM AND APPARATUS FOR DETERMINING A POSE FOR AN OBJECT

(71) Applicant: CANON KABUSHIKI KAISHA, Tokyo (JP)

(72) Inventors: DAVID KARLOV, Emu Plains (AU); ANDREW PETER DOWNING, West Pennant Hills (AU); DIXON DE SHENG DENG, East Ryde (AU); GEOFFREY RICHARD TAYLOR, Carlingford (AU)

(21) Appl. No.: 15/631,957

(22) Filed: Jun. 23, 2017

(51) Int. Cl. G06T 7/73; G06T 7/33; H04N 13/02

(52) U.S. Cl. CPC G06T 7/74; H04N 13/0239; G06T 7/344

(57) ABSTRACT

A method of determining a pose for an object. A plurality of images capturing the object at different viewpoints are received. The viewpoints are related by an angular distance with respect to the object. A feature vector is extracted for the object from each of the received images. Each extracted feature vector is compared with feature vectors from a database to determine a plurality of candidate poses. A pose of the object is determined by comparing candidate poses associated with different ones of the viewpoints, using the angular distance between the viewpoints with respect to the object.

### TECHNICAL FIELD

The present invention relates generally to three-dimensional object recognition and pose estimation and, in particular, to image-based object recognition and pose estimation of featureless objects. The present invention also relates to a method, apparatus and system for determining pose of an object. The present invention also relates to a computer readable medium having a program stored on the medium for determining a pose of an object.

### BACKGROUND

Identifying an object and determining a three-dimensional (3D) pose for the object are useful for a variety of use cases, such as the use of augmented reality or computer vision applications. For example, a custom object may be produced using 3D printing or additive manufacturing techniques, and virtual content may be overlaid on the 3D printed object for visualisation, instruction, validation, or other purposes. 3D printing is gaining in popularity as a manufacturing approach for high-value, low-volume items, including prototyping, due to the ability to produce objects of custom design with low setup costs and lead times.

One method of object identification and pose determination includes matching feature points (“keypoints”) from an object in a scene. However, an object produced by typical 3D printing processes, such as plastic- or resin-based fused deposition modelling (FDM) and stereolithography (SLA), or metal-based selective laser sintering (SLS), generally have a uniform colour and surface texture. Such an object has few or no differentiating feature points, and thus keypoint-based methods have difficulty identifying such objects or estimating the pose of the objects.

The lack of keypoints in a scene may be addressed by attaching markers to the object of interest. Precise markers allow not just feature point matching but direct triangulation between stereo viewpoints to determine the pose of the marker. However, the attachment of markers is a process which can often be tedious and error-prone, and which can significantly decrease the usability of a system, especially for untrained users.

Another template-based method of object identification and pose determination matches dense arrays of data for a test image to a reference image. To work robustly on featureless objects, the arrays of data are not pixel intensities, but contour gradients and surface normal. A dense depth map of a scene needs to be determined, from which surface normals may be computed. Using stereo disparity, standard stereo cameras can produce a depth map for a scene. However, the result is not robust for featureless regions of an image, such as a typical 3D printed object. A reliable depth map may be acquired even for featureless surfaces by use of a special-purpose depth sensor, such as a time-of-flight (ToF) camera. Such special-purpose hardware may be unavailable or undesirable to use in many cases.

### SUMMARY

It is an object of the present invention to substantially overcome, or at least ameliorate, one or more disadvantages of existing arrangements.

Disclosed are arrangements which seek to address the above problems by performing separate lookups on a database prepared in advance, using feature vectors characterising left and right stereo images as lookup keys. Results of the lookups are filtered together according to a stereo constraint.

According to one aspect of the present disclosure, there is provided a method of determining a pose for an object, the method comprising:
receiving a plurality of images capturing the object at different viewpoints, the viewpoints being related by an angular distance with respect to the object;
extracting a feature vector for the object from each of the received images;

comparing each extracted feature vector with feature vectors from a database to determine a plurality of candidate poses; and
determining a pose of the object by comparing candidate poses associated with different ones of the viewpoints, using the angular distance between the viewpoints with respect to the object.

According to another aspect of the present disclosure, there is provided an apparatus for determining a pose for an object, the apparatus comprising:
means for receiving a plurality of images capturing the object at different viewpoints, the viewpoints being related by an angular distance with respect to the object;
means for extracting a feature vector for the object from each of the received images;
means for comparing each extracted feature vector with feature vectors from a database to determine a plurality of candidate poses; and
means for determining a pose of the object by comparing respective candidate poses associated with different ones of the viewpoints, using the angular distance between the viewpoints with respect to the object.

According to still another aspect of the present disclosure, there is provided a system for determining a pose for an object, the system comprising:
a memory for storing data and a computer program;
a processor coupled to the memory for executing the program, the program comprising instructions for:
   receiving a plurality of images capturing the object at different viewpoints, the viewpoints being related by an angular distance with respect to the object;
   extracting a feature vector for the object from each of the received images;
   comparing each extracted feature vector with feature vectors from a database to determine a plurality of candidate poses; and
   determining a pose of the object by comparing respective candidate poses associated with different ones of the viewpoints, using the angular distance between the viewpoints with respect to the object.

According to still another aspect of the present disclosure, there is provided a computer readable medium having a program stored on the medium for determining a pose for an object, the program comprising:
code for receiving a plurality of images capturing the object at different viewpoints, the viewpoints being related by an angular distance with respect to the object;
code for extracting a feature vector for the object from each of the received images;
code for comparing each extracted feature vector with feature vectors from a database to determine a plurality of candidate poses; and
code for determining a pose of the object by comparing respective candidate poses associated with different ones of the viewpoints, using the angular distance between the viewpoints with respect to the object.

Other aspects of the invention are also disclosed.

### BRIEF DESCRIPTION OF THE DRAWINGS

One or more embodiments of the invention will now be described with reference to the following drawings, in which:

FIG. 1 is a schematic block diagram of a data processing architecture;

FIG. 2 is a schematic flow diagram showing a method of determining pose for an object;

FIG. 3 is a schematic flow diagram showing a method of preparing a feature database as used in the method of FIG. 2;

FIG. 4 is a schematic flow diagram showing a method of querying a database as used in the method of FIG. 2;

FIG. 5 is a schematic flow diagram showing a method of extracting features as used in the methods of FIG. 3 and FIG. 4;

FIG. 6 is a schematic flow diagram showing a method of determining a cost score as used in the method of FIG. 2;

FIG. 7 is a schematic flow diagram showing a method of determining an object ID and a pose as used in the method of FIG. 2;

FIGS. 8A and 8B show a stereo imaging arrangement;

FIG. 9A shows two lists of clusters;

FIG. 9B shows two lists of clusters and six cluster pairs;

FIG. 10A shows a database with database entries;

FIG. 10B shows the database of FIG. 10A with database entries according to another arrangement;

FIG. 11A shows a silhouette image comprising object pixels;

FIG. 11B shows four annulus rings;

FIG. 11C shows the annulus rings of FIG. 11B overlayed on the image of FIG. 11A;

FIG. 12 shows a 2D rotation process according to one embodiment of the invention; and

FIGS. 13A and 13B form a schematic block diagram of a general purpose computer system upon which arrangements described can be practiced.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

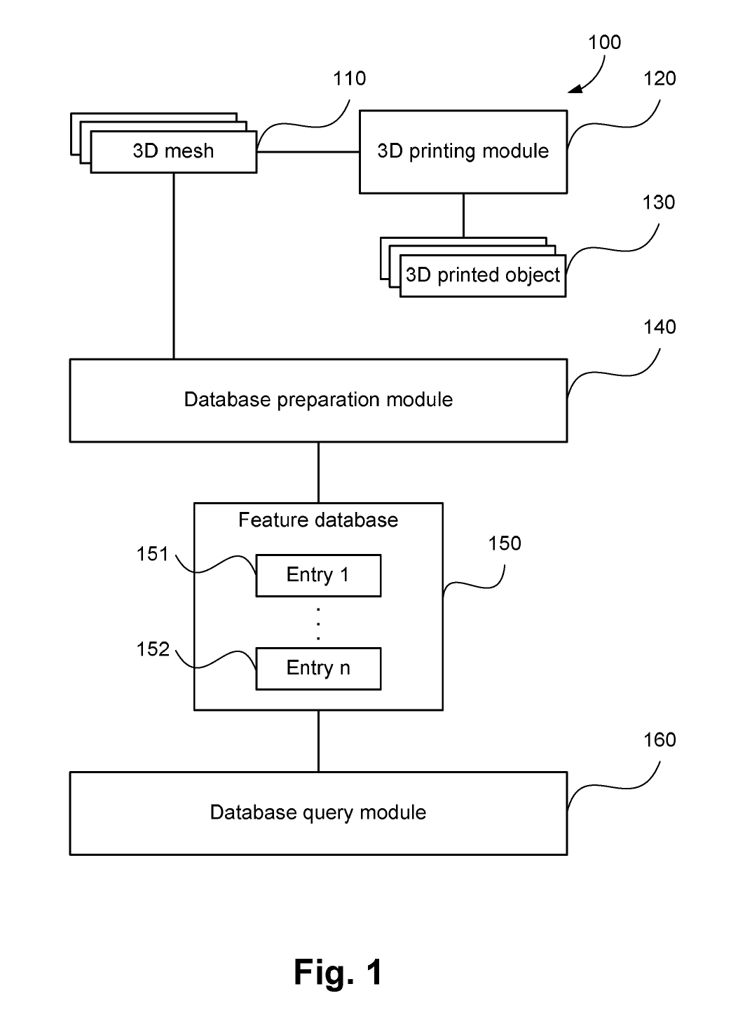

FIG. 1 shows a software architecture 100 for object identification and pose determination of three dimensional (3D) printed objects. One or more known digital 3D meshes 110 are provided to 3D printing module 120 to create physical 3D printed objects 130 corresponding to each mesh 110 according to a standard 3D printing process. The 3D printed objects 130 may be produced for industrial prototyping or other purposes, and may be uniform in surface colour and texture.

To enhance the processing or the use of the 3D printed objects 130, the architecture 100 includes a database preparation module 140, which processes the 3D meshes 110 to prepare a feature database 150 with feature data for each of the object meshes 110. The feature database 150 contains entries 151-152 corresponding to poses of one or more 3D mesh 110.

The database query module 160 performs queries on the feature database 150 in order to identify a 3D printed object 130 and a pose of the object 130 from images of the object 130.

Although methods described below are described in the context of objects produced by a standard 3D printing process, the described methods are not limited to 3D printed objects. The described methods can identify and determine a pose of any physical object for which a corresponding 3D model is known.

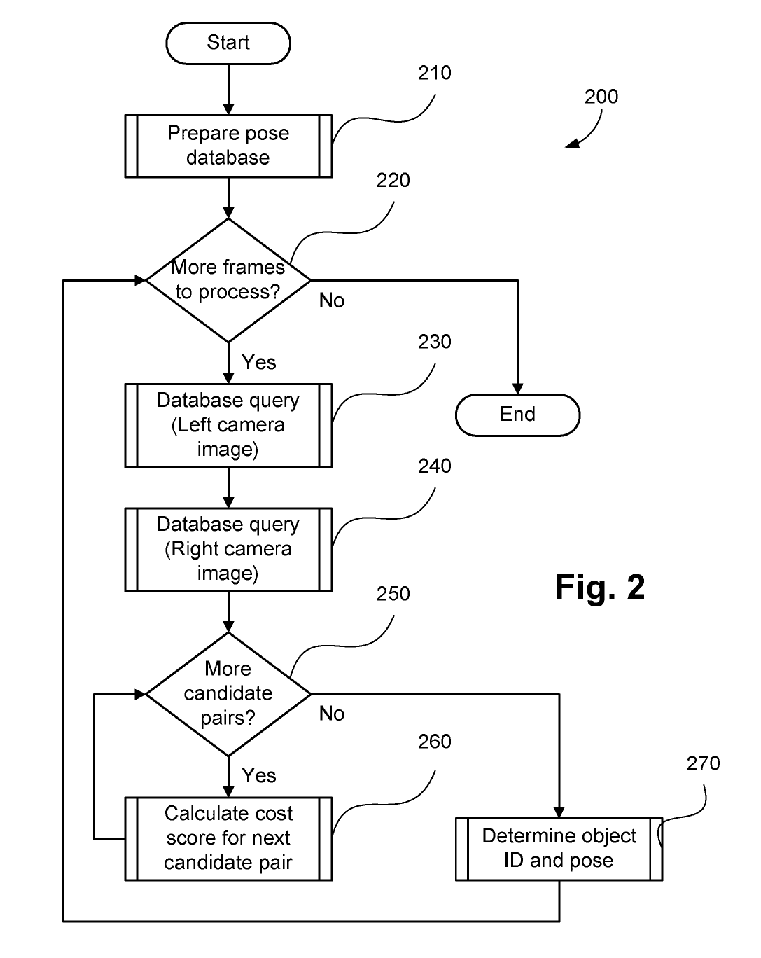

A method 200 of determining a pose of a 3D printed object will be described in detail below with reference FIG. 2.

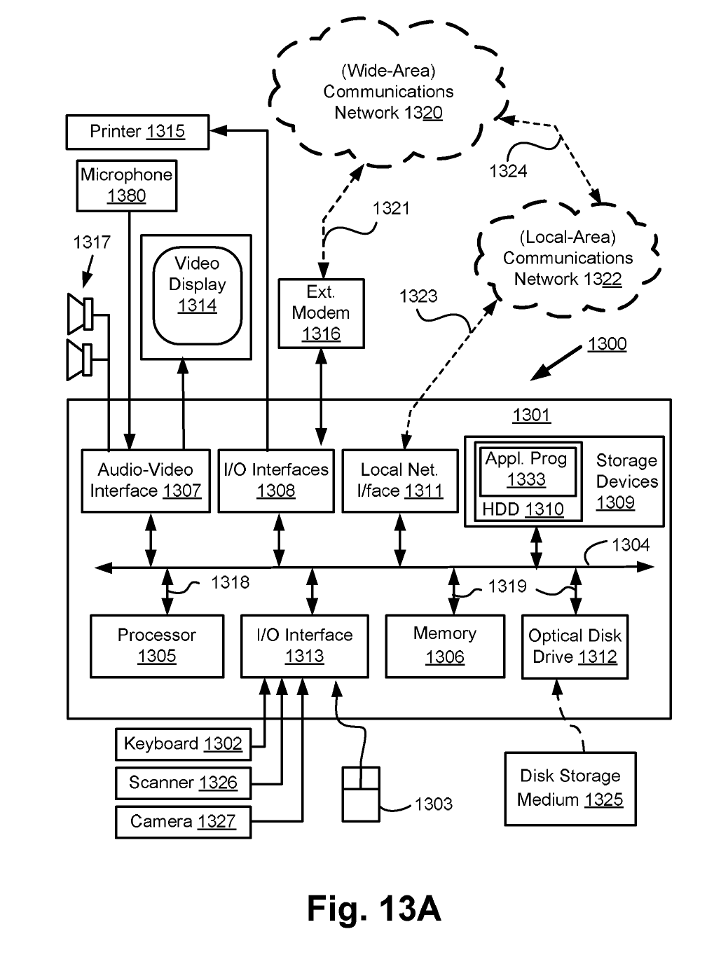

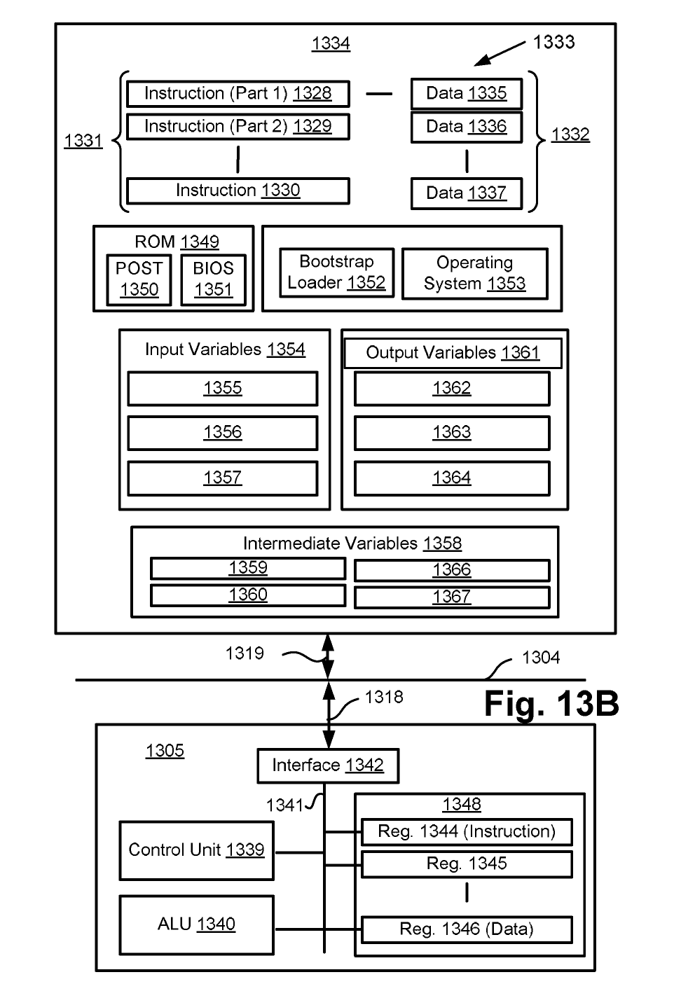

FIGS. 13A and 13B depict a general-purpose computer system 1300, upon which the various arrangements described can be practiced.

As seen in FIG. 13A, the computer system 1300 includes: a computer module 1301; input devices such as a keyboard 1302, a mouse pointer device 1303, a scanner 1326, a camera 1327, and a microphone 1380; and output devices including a printer 1315, a display device 1314 and loudspeakers 1317. An external Modulator-Demodulator (Modem) transceiver device 1316 may be used by the computer module 1301 for communicating to and from a communications network 1320 via a connection 1321. The communications network 1320 may be a wide-area network (WAN), such as the Internet, a cellular telecommunications network, or a private WAN. Where the connection 1321 is a telephone line, the modem 1316 may be a traditional “dial-up” modem. Alternatively, where the connection 1321 is a high capacity (e.g., cable) connection, the modem 1316 may be a broadband modem. A wireless modem may also be used for wireless connection to the communications network 1320.

The computer module 1301 typically includes at least one processor unit 1305, and a memory unit 1306. For example, the memory unit 1306 may have semiconductor random access memory (RAM) and semiconductor read only memory (ROM). The computer module 1301 also includes a number of input/output (I/O) interfaces including: an audio-video interface 1307 that couples to the video display 1314, loudspeakers 1317 and microphone 1380; an I/O interface 1313 that couples to the keyboard 1302, mouse 1303, scanner 1326, camera 1327 and optionally a joystick or other human interface device (not illustrated); and an interface 1308 for the external modem 1316 and printer 1315. In some implementations, the modem 1316 may be incorporated within the computer module 1301, for example within the interface 1308. The computer module 1301 also has a local network interface 1311, which permits coupling of the computer system 1300 via a connection 1323 to a local-area communications network 1322, known as a Local Area Network (LAN). As illustrated in FIG. 13A, the local communications network 1322 may also couple to the wide network 1320 via a connection 1324, which would typically include a so-called “firewall” device or device of similar functionality. The local network interface 1311 may comprise an Ethernet circuit card, a Bluetooth® wireless arrangement or an IEEE 802.11 wireless arrangement; however, numerous other types of interfaces may be practiced for the interface 1311.

The I/O interfaces 1308 and 1313 may afford either or both of serial and parallel connectivity, the former typically being implemented according to the Universal Serial Bus (USB) standards and having corresponding USB connectors (not illustrated). Storage devices 1309 are provided and typically include a hard disk drive (HDD) 1310. Other storage devices such as a floppy disk drive and a magnetic tape drive (not illustrated) may also be used. An optical disk drive 1312 is typically provided to act as a non-volatile source of data. Portable memory devices, such optical disks (e.g., CD-ROM, DVD, Blu-ray USB-RAM, portable, external hard drives, and floppy disks, for example, may be used as appropriate sources of data to the system 1300.

The components 1305 to 1313 of the computer module 1301 typically communicate via an interconnected bus 1304 and in a manner that results in a conventional mode of operation of the computer system 1300 known to those in the relevant art. For example, the processor 1305 is coupled to the system bus 1304 using a connection 1318. Likewise, the memory 1306 and optical disk drive 1312 are coupled to the system bus 1304 by connections 1319. Examples of computers on which the described arrangements can be practised include IBM-PC's and compatibles, Sun Sparcstations, Apple Mac™ or like computer systems.

The method 200 of determining a pose for an object and other methods described below may be implemented using the computer system 1300 wherein the processes of FIGS. 2, 3, 4, 5, 6 and 7, to be described, may be implemented as one or more software application programs 1333 executable within the computer system 1300. In particular, the steps of the described methods are effected by instructions 1331 (see FIG. 13B) in the software 1333 that are carried out within the computer system 1300. The software instructions 1331 may be formed as one or more of the software modules 120, 140 and 160 of FIG. 1, each of the modules 120, 140 and 160 being configured for performing one or more particular tasks as described above. The software may also be divided into two separate parts, in which a first part and the corresponding code modules performs the described methods and a second part and the corresponding code modules manage a user interface between the first part and the user.

The software may be stored in a computer readable medium, including the storage devices described below, for example. The software 1333 is typically stored in the HDD 1310 or the memory 1306. The software is loaded into the computer system 1300 from the computer readable medium, and then executed by the computer system 1300. Thus, for example, the software 1333 may be stored on an optically readable disk storage medium (e.g., CD-ROM) 1325 that is read by the optical disk drive 1312. A computer readable medium having such software or computer program recorded on the computer readable medium is a computer program product. The use of the computer program product in the computer system 1300 preferably effects an advantageous apparatus for implementing the described methods.

In some instances, the application programs 1333 may be supplied to the user encoded on one or more CD-ROMs 1325 and read via the corresponding drive 1312, or alternatively may be read by the user from the networks 1320 or 1322. Still further, the software can also be loaded into the computer system 1300 from other computer readable media. Computer readable storage media refers to any non-transitory tangible storage medium that provides recorded instructions and/or data to the computer system 1300 for execution and/or processing. Examples of such storage media include floppy disks, magnetic tape, CD-ROM, DVD, Blu-ray Disc, a hard disk drive, a ROM or integrated circuit, USB memory, a magneto-optical disk, or a computer readable card such as a PCMCIA card and the like, whether or not such devices are internal or external of the computer module 1301. Examples of transitory or non-tangible computer readable transmission media that may also participate in the provision of software, application programs, instructions and/or data to the computer module 1301 include radio or infra-red transmission channels as well as a network connection to another computer or networked device, and the Internet or Intranets including e-mail transmissions and information recorded on Websites and the like.

The second part of the application programs 1333 and the corresponding code modules mentioned above may be executed to implement one or more graphical user interfaces (GUIs) to be rendered or otherwise represented upon the display 1314. Through manipulation of typically the keyboard 1302 and the mouse 1303, a user of the computer system 1300 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1317 and user voice commands input via the microphone 1380.

FIG. 13B is a detailed schematic block diagram of the processor 1305 and a “memory” 1334. The memory 1334 represents a logical aggregation of all the memory modules (including the HDD 1309 and semiconductor memory 1306) that can be accessed by the computer module 1301 in FIG. 13A.

When the computer module 1301 is initially powered up, a power-on self-test (POST) program 1350 executes. The POST program 1350 is typically stored in a ROM 1349 of the semiconductor memory 1306 of FIG. 13A. A hardware device such as the ROM 1349 storing software is sometimes referred to as firmware. The POST program 1350 examines hardware within the computer module 1301 to ensure proper functioning and typically checks the processor 1305, the memory 1334 ( 1309, 1306), and a basic input-output systems software (BIOS) module 1351, also typically stored in the ROM 1349, for correct operation. Once the POST program 1350 has run successfully, the BIOS 1351 activates the hard disk drive 1310 of FIG. 13A. Activation of the hard disk drive 1310 causes a bootstrap loader program 1352 that is resident on the hard disk drive 1310 to execute via the processor 1305. This loads an operating system 1353 into the RAM memory 1306, upon which the operating system 1353 commences operation. The operating system 1353 is a system level application, executable by the processor 1305, to fulfil various high level functions, including processor management, memory management, device management, storage management, software application interface, and generic user interface.

The operating system 1353 manages the memory 1334 ( 1309, 1306) to ensure that each process or application running on the computer module 1301 has sufficient memory in which to execute without colliding with memory allocated to another process. Furthermore, the different types of memory available in the system 1300 of FIG. 13A must be used properly so that each process can run effectively. Accordingly, the aggregated memory 1334 is not intended to illustrate how particular segments of memory are allocated (unless otherwise stated), but rather to provide a general view of the memory accessible by the computer system 1300 and how such is used.

As shown in FIG. 13B, the processor 1305 includes a number of functional modules including a control unit 1339, an arithmetic logic unit (ALU) 1340, and a local or internal memory 1348, sometimes called a cache memory. The cache memory 1348 typically includes a number of storage registers 1344-1346 in a register section. One or more internal busses 1341 functionally interconnect these functional modules. The processor 1305 typically also has one or more interfaces 1342 for communicating with external devices via the system bus 1304, using a connection 1318. The memory 1334 is coupled to the bus 1304 using a connection 1319.

The application program 1333 includes a sequence of instructions 1331 that may include conditional branch and loop instructions. The program 1333 may also include data 1332 which is used in execution of the program 1333. The instructions 1331 and the data 1332 are stored in memory locations 1328, 1329, 1330 and 1335, 1336, 1337, respectively. Depending upon the relative size of the instructions 1331 and the memory locations 1328-1330, a particular instruction may be stored in a single memory location as depicted by the instruction shown in the memory location 1330. Alternately, an instruction may be segmented into a number of parts each of which is stored in a separate memory location, as depicted by the instruction segments shown in the memory locations 1328 and 1329.

In general, the processor 1305 is given a set of instructions which are executed therein. The processor 1105 waits for a subsequent input, to which the processor 1305 reacts to by executing another set of instructions. Each input may be provided from one or more of a number of sources, including data generated by one or more of the input devices 1302, 1303, data received from an external source across one of the networks 1320, 1302, data retrieved from one of the storage devices 1306, 1309 or data retrieved from a storage medium 1325 inserted into the corresponding reader 1312, all depicted in FIG. 13A. The execution of a set of the instructions may in some cases result in output of data. Execution may also involve storing data or variables to the memory 1334.

The disclosed arrangements use input variables 1354, which are stored in the memory 1334 in corresponding memory locations 1355, 1356, 1357. The disclosed arrangements produce output variables 1361, which are stored in the memory 1334 in corresponding memory locations 1362, 1363, 1364. Intermediate variables 1358 may be stored in memory locations 1359, 1360, 1366 and 1367.

Referring to the processor 1305 of FIG. 13B, the registers 1344, 1345, 1346, the arithmetic logic unit (ALU) 1340, and the control unit 1339 work together to perform sequences of micro-operations needed to perform “fetch, decode, and execute” cycles for every instruction in the instruction set making up the program 1333. Each fetch, decode, and execute cycle comprises:
a fetch operation, which fetches or reads an instruction 1331 from a memory location 1328, 1329, 1330;
a decode operation in which the control unit 1339 determines which instruction has been fetched; and
an execute operation in which the control unit 1339 and/or the ALU 1340 execute the instruction.

Thereafter, a further fetch, decode, and execute cycle for the next instruction may be executed. Similarly, a store cycle may be performed by which the control unit 1339 stores or writes a value to a memory location 1332.

Each step or sub-process in the processes of FIGS. 2, 3, 4, 5, 6 and 7 is associated with one or more segments of the program 1333 and is performed by the register section 1344, 1345, 1347, the ALU 1340, and the control unit 1339 in the processor 1305 working together to perform the fetch, decode, and execute cycles for every instruction in the instruction set for the noted segments of the program 1333.

The described methods may alternatively be implemented in dedicated hardware such as one or more integrated circuits performing the functions or sub functions of the described methods. Such dedicated hardware may include graphic processors, digital signal processors, or one or more microprocessors and associated memories.

The software instructions 1331 may be formed as one or more of the software modules 120, 140 and 160 of FIG. 1, each of the modules 120, 140 and 160 being configured for performing one or more particular tasks as described above.

The method 200 may be implemented as one of more of the software code modules 120, 140 and 160 forming the software application programs 1333. The software 1333 implementing the method 200 may be resident in the hard disk drive 1310 and be controlled in its execution by the processor 1305. The method 200 will be described by way of example with reference to FIG. 1. The method 200 identifies a 3D printed object 130 and a pose of the object 130.

The method 200 begins with pose database preparation step 210, where database preparation module 140, under execution of the processor 1305, processes the 3D meshes 110 to prepare the feature database 150 with feature data for each of the object meshes 110. The feature database 150 may be configured within the hard disk drive 1310.

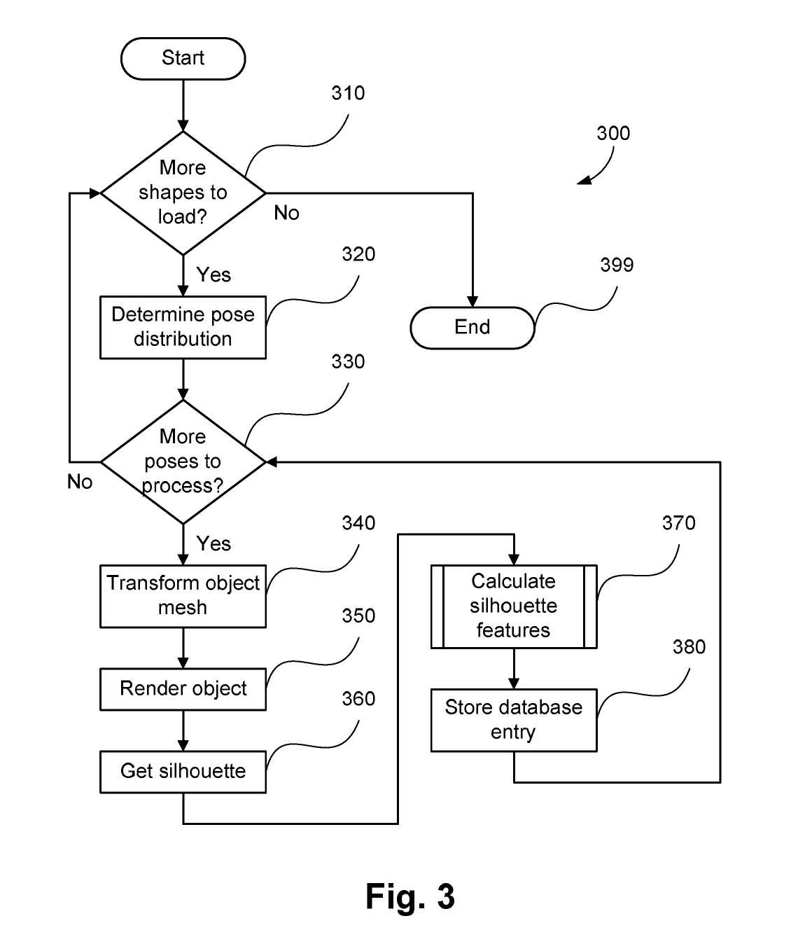

Step 210 is performed offline, and may be performed prior, during, or after the production of the 3D printed object 130 from a mesh 110 by 3D printing module 120. A method 300 of preparing the feature database 150, as executed at step step 210, will be described in detail with reference to FIG. 3.

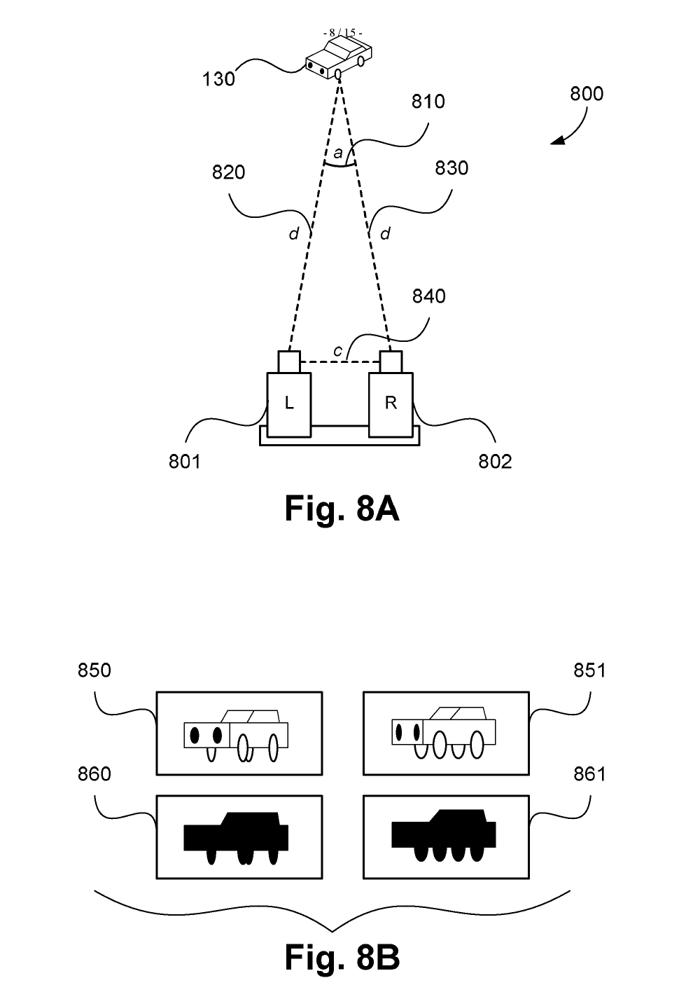

The remaining steps 220- 270 of the method 200 are performed by the database query module 160 under execution of the processor 1305. The steps 220, 230, 240, 250 and 260 are online steps, performed after 3D printing module 120 produces a 3D printed object 130 from a mesh 110. The steps 220, 230, 240, 250 and 260 use images of the 3D printed object 130, such as a left image 850 and right image 851, captured by left camera 801 and right camera 802 respectively, as shown in FIG. 8A and FIG. 8B.

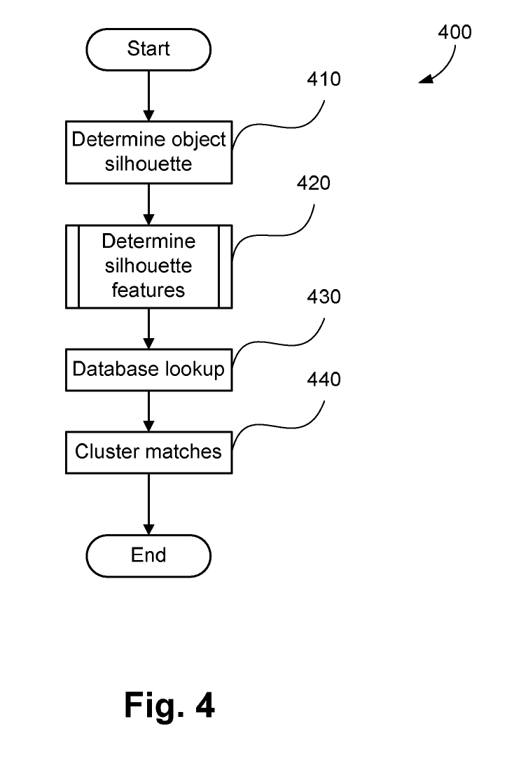

At loop condition step 220, if no further image frames are to be processed, then the method 200 terminates. Otherwise, while there are further frames to process, a left image frame 850 and right image frame 851 are provided to database query steps 230 and 240 respectively. A method 400 of querying a database, as executed at steps 230 and 240, will be described in detail with reference to FIG. 4.

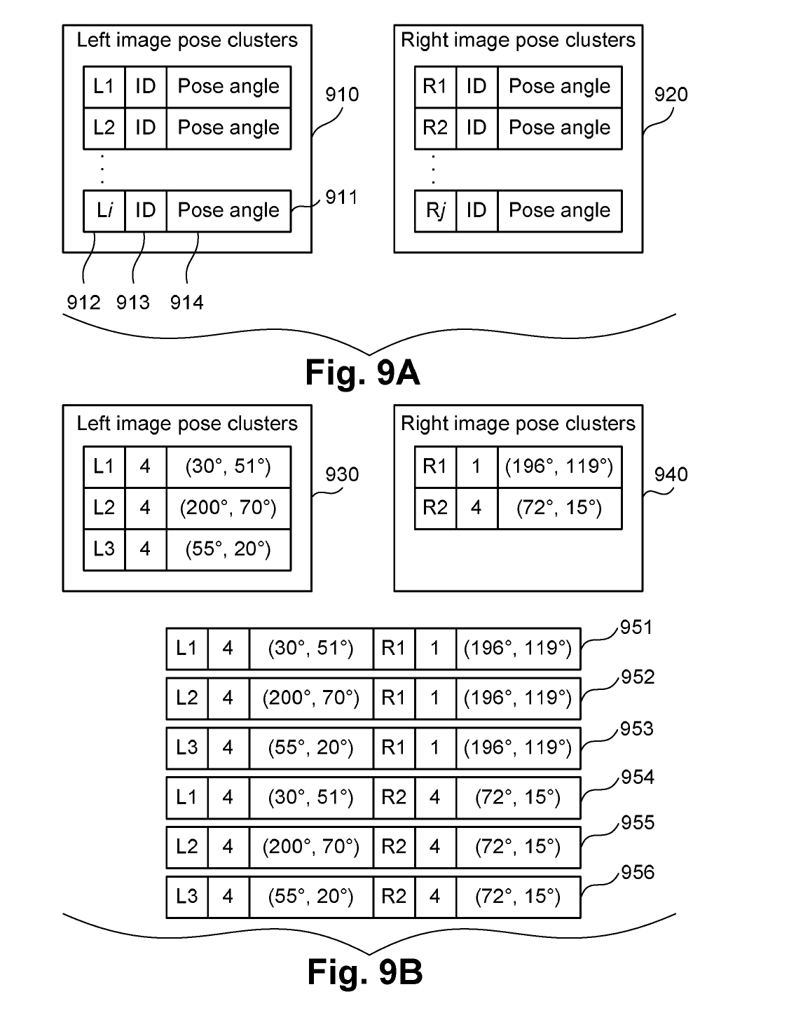

The result of performing database query steps 230 and 240 is two lists of clusters of candidate object identifiers (IDs) and pose angles which may be stored within the memory 1306. As shown in FIG. 9A, there is one list 910 for the left clusters, and another list 920 for the right clusters. Each of the lists 910 and 920 contains a number of clusters. Each cluster 911 contains an index 912, an object ID 913, and a pose angle 914. The pose angle 914 of a cluster may be determined as an average pose angle of cluster members, or the pose angle of a single representative member.

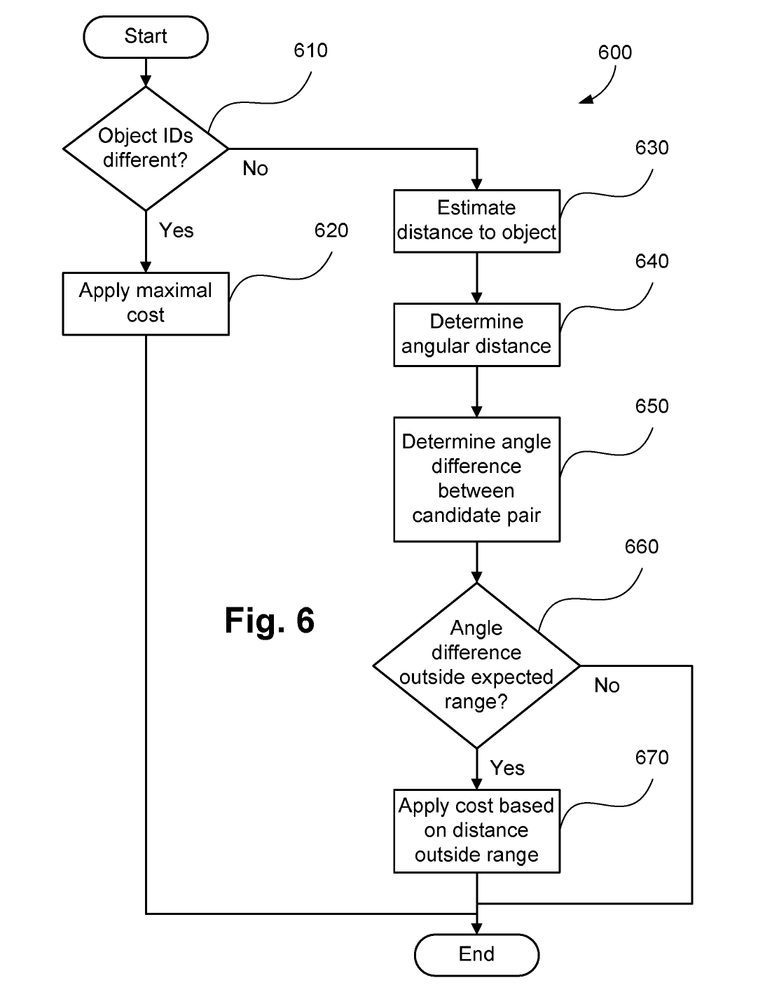

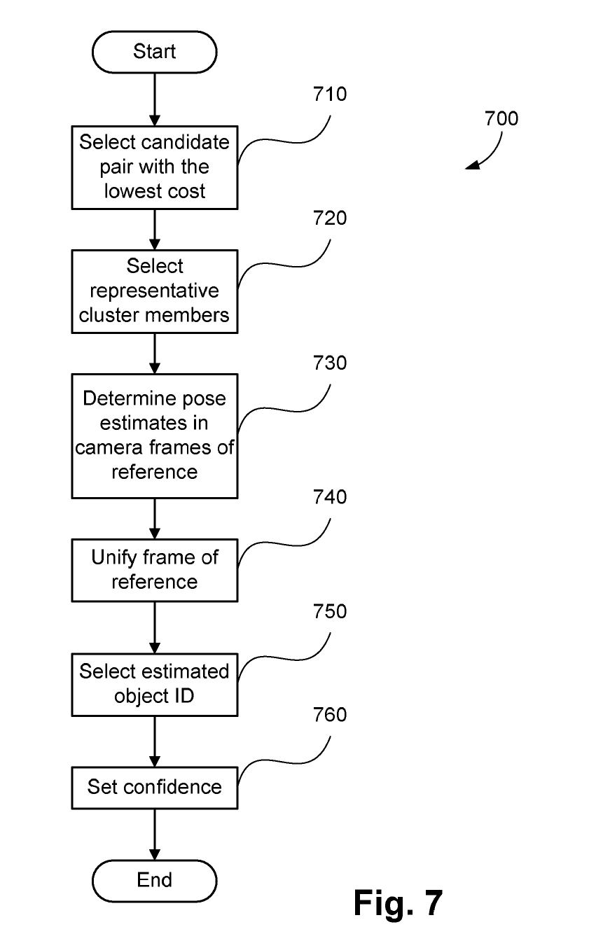

The possible combinations of candidate cluster pairs are formed into a list, and each candidate pair is considered in turn, with inner loop condition step 250 checking whether a pair of candidate cluster pairs exists which has not yet been processed. If there are more candidate pairs to process, then the method 200 proceeds to determining step 260 where a cost score is determined for the next pair of candidate cluster pairs. The cost score determined at step 260 may be stored in the memory 1306. A method 600 of determining a cost score, as invoked at step 260, will be described in detail with reference to FIG. 6. Each candidate pair is scored in turn, until there are no further pairs to process. Then at determining step 270, the results of the scoring loop are used to determine an object ID and a pose for the imaged object. At step 270, the candidate pair with the lowest cost is selected, and the object ID and pose angles of the selected candidate pair are used to determine a pose of the object. The object ID and pose angles determined at step 270 may be stored in the memory 1306. A method 700 of determining an object ID and pose, as invoked at step 270, will be described in detail with reference to FIG. 7.

The 3D pose angles may be used in several ways. The 3D pose angles may be augmented with a further three dimensions of positional information, or the 3D pose angles may be transformed from the left and right camera co-ordinate systems into a global co-ordinate system. The 3D poses may be used to compose virtual 3D content with an image of the physical content, such that the virtual content overlays the physical object, moves with the object, and appears to be a part of the object. The virtual 3D content may be composed with an image of the physical content by means of a device such as a video see-through or optical see-through mixed or augmented reality headset, or tablet device.

The methods described herein with reference to FIGS. 2, 3, 4, 5, 6 and 7, are not limited to augmented reality applications, and may also be applied to other systems and environments, such as machine vision systems in industrial settings.

The method 300 of preparing the feature database 150, as invoked at step 210 of the method 200, will now be described with reference to FIG. 3. The method 300 populates the feature database 150 according to a selected set of 3D mesh shapes and number of poses. The method 300 may be implemented by the preparation module 140 forming part of the software 1333 resident in the hard disk drive 1310 and being controlled in its execution by the processor 1305.

The method 300 begins at shape loading loop condition step 310, where if there are additional 3D mesh shapes which are to be loaded into the feature database 150 then the method 300 proceeds to step determining step 320. Otherwise, if there are no more shapes to be loaded, then the method 300 terminates. Loading starts by determining a pose distribution at step 320. The pose distribution is a selection of poses for which features are from the digital 3D mesh. The pose distribution may be stored in the memory 1306. In one arrangement, the pose distribution has complete coverage of the pose space. The pose space may be a two-valued spherical angle space, such as may be generated by viewing a fixed object from sample points on the surface of a sphere enclosing the object. In one arrangement of the sampling distribution, as uniform a sampling as possible is performed at step 320. In the case of a two-valued spherical angle space, a sampling with high uniformity may be determined using a spherical Fibonacci point set. A point i in a spherical Fibonacci point set has angles (φ, θ) conforming to the equations

$$ϕ = 2 π [ \frac{i}{Φ} ] and θ = arccos ( 1 - \frac{2 i + 1}{n} ) .$$

That is, the phi angle is the fractional part of the point index divided by the golden ratio, projected onto a circle by multiplying by two pi, and the theta angle is the inverse cosine of a value that decreases at a constant rate from around one (1) to negative one (−1) as the point index varies from minimum to maximum.

Other arrangements of the sampling distribution are possible, such as sampling regions of the angle space with a non-uniform density. For example, sampling may be performed at a higher density over regions of the pose space for which a determined feature varies more rapidly. Such a sampling method produces a pose distribution which depends on the shape.

The number of poses of the pose distribution trades-off with accuracy: more poses reduces the mean distance between poses in the pose space, increasing accuracy of the method 200, but occupying more memory 1306, and taking longer to determine. A number of poses in the order of 20,000 results in a spherical angle distance between neighbouring samples in the order of 1°, which produces good results in practice.

After the pose distribution has been determined in step 320, the mesh is processed for each pose in the distribution in a loop starting at inner loop condition step 330, where if there are more poses to process then the next pose is selected and the method 300 proceeds to transforming step 340. If all poses are processed, then the inner loop completes and the method 300 returns to outer loop condition step 310 to load any further shapes into the database 150.

The 3D object mesh is transformed according to the selected pose in transformation step 340. The 3D mesh can be transformed in a typical 3D graphical rendering system by multiplying a view matrix by a transformation matrix which performs rotation of the phi value around the X axis for the pose, then by a transformation matrix which performs rotation of the theta value around the Z axis for the pose, and applying the view matrix to each vertex co-ordinate forming the mesh. The transformed 3D mesh may be stored in the memory 1306.

The mesh is then rendered to an image in rendering step 350 using any suitable 3D mesh rendering method. The image may be rendered at step 350 into the memory 1306 and/or onto the display 1314. The rendering performed at step 350 may use the same intrinsic parameters for a virtual camera as the parameters of the left physical camera (e.g., 801) and right physical camera (e.g., 820) of a viewing system being used. After rendering, the silhouette of the rendered object pixels is determined in silhouette determining step 360.

Step 360 may be implemented by setting a background colour across the whole view prior to rendering, then rendering the object. Pixels which were overwritten when rendering the object are classified as foreground, and pixels which remain the background colour are classified as background. As such, by classifying pixels as foreground and background, a binary silhouette image is created with foreground pixels representing a silhouette of the object.

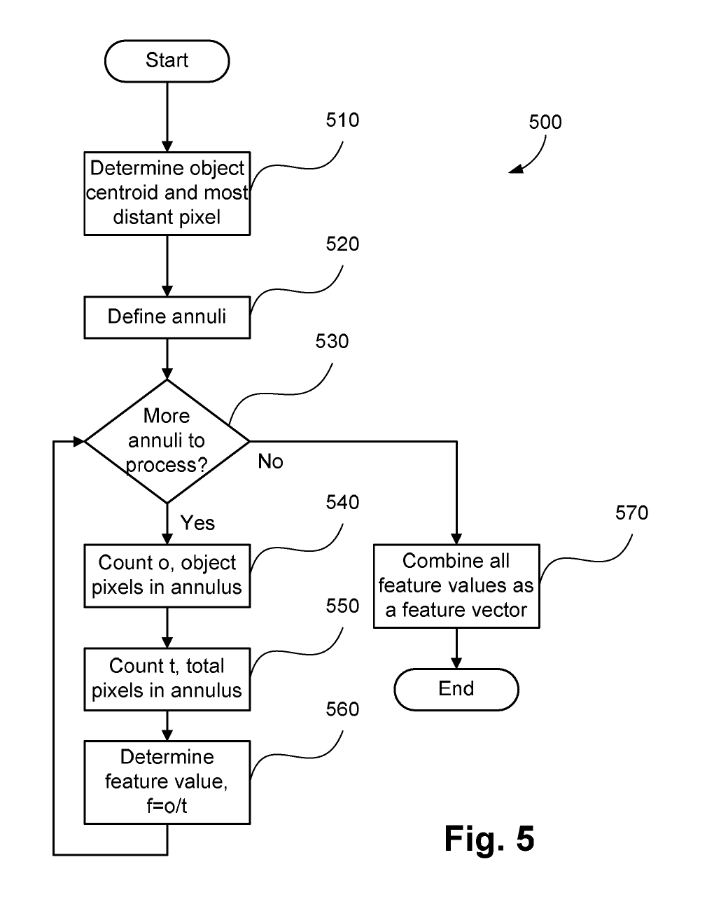

At determining step 370, a numerical vector of features is extracted from the binary silhouette image. The numerical vector of features characterise the silhouette of the object for the current pose. A method 500 of extracting a numerical feature of vectors, as executed at step 370, will be described in more detail with reference to FIG. 5.

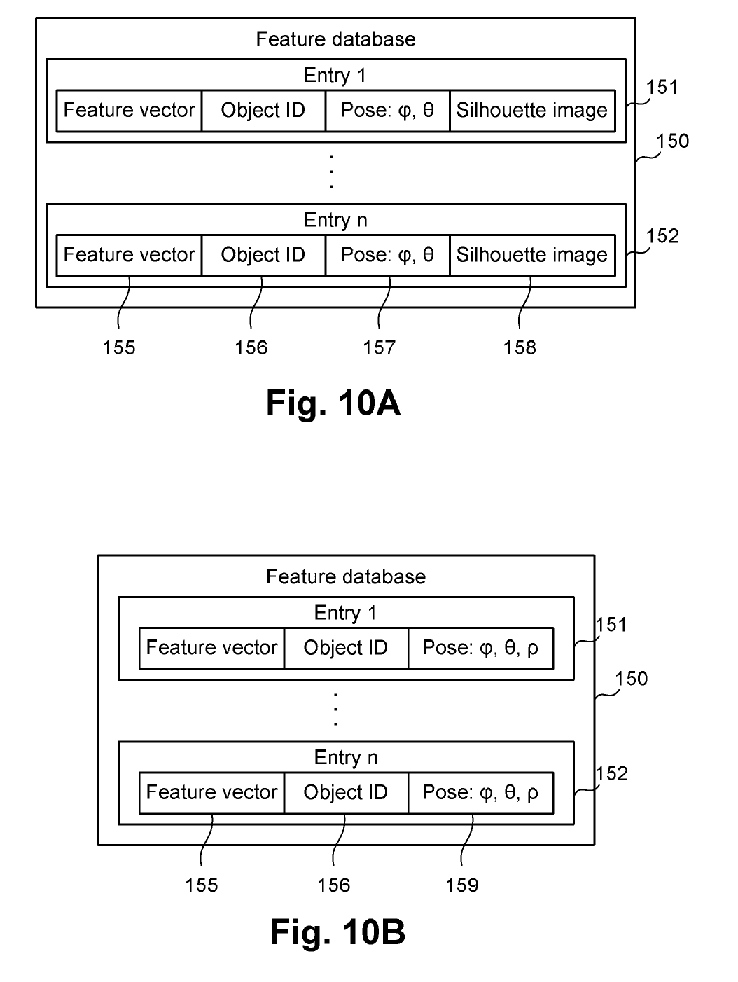

In storing step 380, an entry 152 (see FIG. 1) is stored in the database 150 configured within the hard disk drive 1310. With reference to FIG. 10A, the added database entry 152 contains feature vector 155 produced in step 370 as the database key, and payload data consisting of the ID 156 of the object or shape loaded in step 310, the pose 157 corresponding to the transform applied to the shape at step 340, and the silhouette image 158 extracted at step 360. The added database entry 152 may be compressed. Although orientation of an object in 3D space requires three angles to describe, in one arrangement the pose 157 comprises two angles, phi and theta; the third angle describing the pose, rho, has an implicit value of zero which is not stored. After storing a database entry for the current pose, processing returns to step 330, where a check is performed to determine if the current shape has more poses to process.

The method 400 of querying a database, as executed at steps 230 and 240, will now be described in detail with reference to FIG. 4. The method 400 may be implemented by the database query module 160 forming part of the software 1333 resident in the hard disk drive 1310 and being controlled in its execution by the processor 1305. The method 300 is invoked at steps 230 and 240 of the method 200 for the left and right camera images respectively. The method 400 prepares for, invokes, and performs initial post-processing on the results of a query operation on the feature database 150, in order to identify the pose of a 3D printed object 130 from an image.

The method 400 begins at determining step 410, where the silhouette of an object in the image is determined under execution of the processor 1305. The determined silhouette may be stored within the memory 1306. For 3D printed objects of uniform colour, the silhouette may be determined at step 410 by colour masking, in which pixels of a colour within some range according to the colour of the 3D printed object are considered object pixels, and other pixels are considered background pixels. Alternatively, the silhouette may be determined at step 410 using edge detection, in which pixels contained within the edge of a foreground object are considered object pixels, and other pixels are considered background pixels. Other methods for determining an object silhouette are possible, including determination of multiple silhouettes where multiple objects are present in the scene. Image segmentation may also be used in determining the object silhouette. The result of the silhouette determination step 410 is a binary image consisting of object pixels and background pixels. The binary image may be stored within the memory 1306. In one example, as shown in FIG. 8B, applying step 410 to camera image 850 produces binary silhouette image 860, and applying step 410 to camera image 851 produces binary silhouette image 861.

After an object silhouette 860 has been determined, the method 400 proceeds to determining step 420 where a feature extraction process is operated on the binary silhouette image 860 to determine silhouette features. The method 500 is executed at step step 420 to determine silhouette features, which is the same feature extraction method invoked in step 370 of the method 300. The feature extraction step 370 produces a numerical vector of features which characterise the silhouette 860 of the object in the captured image 850. The silhouette features determined at step 420 may be stored in the memory 1306.

In lookup step 430, the feature vector is used as a query key in a lookup performed on the feature database 150 configured within the hard disk drive 1310. The lookup is a “ball query” operation in the n-dimensional feature space of the feature vector. For example, with a 40-dimensional feature vector (a vector containing forty (40) numerical values), the ball query operates in a 40-dimensional feature space. The ball query selects and returns a set of matches in the database 150 based on a match score. All entries in the database 150 which lie within some radius distance of the query point in the high-dimensional feature space are retrieved. The distance may be Euclidean (L2 norm). However, other distances may also be used. The radius of the ball query is set such that the possibility of any query for an image of an object which has been loaded into the database 150 according to the method 300 returning zero results is negligible. In a typical query, a number of results greater than one is expected. Since exact ball queries are difficult to operate at high speeds in high dimensions, an approximate ball query may be used at step 430. However, any suitable high dimensional ball query may be used at step 430.

Since AR applications are typically performance-critical, with frame rates of sixty (60) frames per second or more required to seamlessly compose virtual content with a real scene, a hash-table-based operation over a lattice structure may be used at step 430. The hash-table-based operation operates in constant time with respect to the number of database entries, and is linear with respect to the number of dimensions.

Since the database lookup step 430 typically results in a set of matched entries, rather than a single entry, narrowing down the estimated object ID and pose candidates into a single estimation requires some further processing. The method 400 performs an initial database result post-processing step 440 where the set of matches determined at step 430 are clustered under execution of the processor 1305. Step 440 generally speeds up subsequent post-processing. The result of the clustering performed at step 440 is that candidate matches having the same object ID 156 and similar pose angles 157 are combined into the same cluster. A clustering angle difference threshold may be applied to control the degree of clustering. For example, with a clustering angle difference of 5°, a candidate pose whose angle difference to a cluster's average angle is more than 5° will not join the cluster, and may instead start a new cluster. After the candidate matches have been clustered, the database query process 400 terminates.

The method 500 of extracting a numerical feature of vectors, as invoked at step 370 of the method 300 and at step 420 of the method 400, will now be described with reference to FIG. 5. The method 500 may be implemented by the database query module 160 forming part of the software 1333 resident in the hard disk drive 1310 and being controlled in its execution by the processor 1305.

The method 500 produces a list of numerical values (a “feature vector”) which collectively characterise a silhouette image.

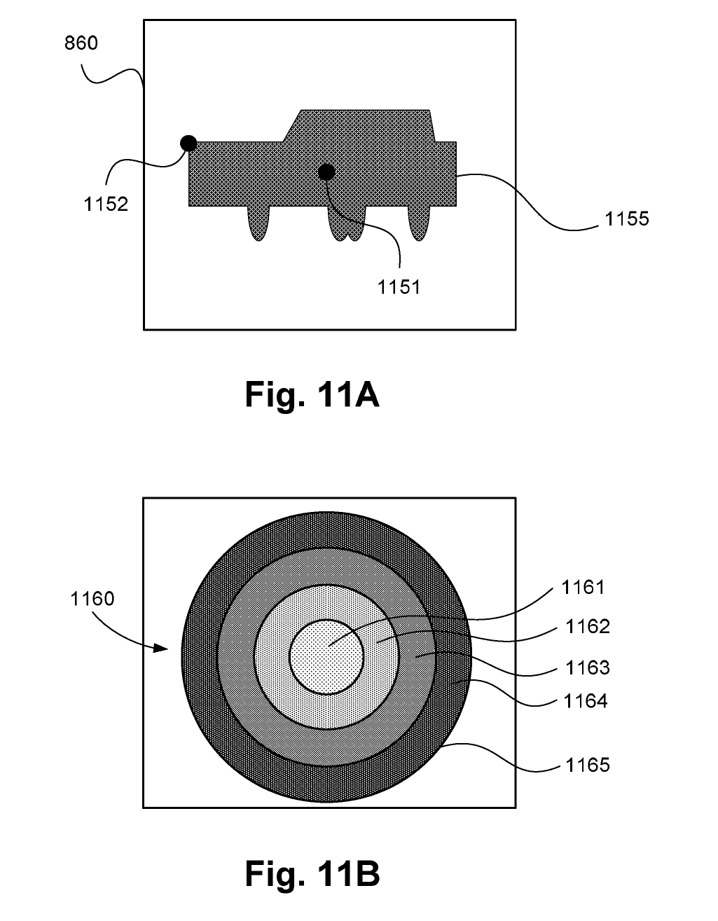

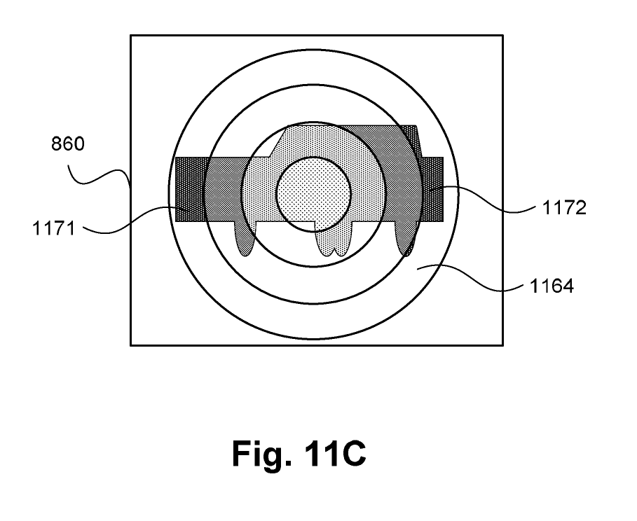

The method 500 begins at determining step 510, where the centroid of the object 130 is determined under execution of the processor 1305. The most distant pixel of the object 130 is also determined at step 510. The centroid and most distant pixel determined at step 510 may be stored in the memory 1306 under execution of the processor 1305. With reference to FIG. 11A, step 510 depends on the object pixels 1155 of silhouette image 860. The object pixels 1155 are the pixels which are determined to be part of the object 130 being imaged, as opposed to part of the background. The centroid 1151 of the object 130 is the image pixel whose X co-ordinate is the average of X co-ordinates of all object pixels, and whose Y co-ordinate is the average of Y co-ordinates of all object pixels. The centroid 1151 of the object 130 need not be an object pixel. For example, in the case of a doughnut viewed from above, the object centroid will lie in the doughnut hole. The most distant pixel 1152 is an object pixel whose Euclidean distance from the object centroid 1151 is the largest.

The method 500 continues at defining step 520, where a set of annulus rings 1160 are defined, overlaying the silhouette image. In order to achieve translational invariance (i.e., to ensure the feature remains characteristic of the object silhouette regardless of the position of the silhouette within the image), the centre of each ring is set to object centroid 1151. In order to achieve scale invariance (i.e., to ensure the feature remains characteristic of the object silhouette regardless of the distance at which the image was captured), the radius of the outer boundary 1165 of the outer-most annulus ring 1164 is set to the distance of the most distant object pixel 1152 from the object centroid 1151. The area within the outer boundary 1165 is divided into annuli 1161, 1162, 1163, and 1164. FIG. 11B shows four example annulus rings. In practice, more than four annuli are used. The number of annulus rings determines the number of features extracted from the image. The number of rings may be tuned; too many rings become susceptible to noise in camera images and silhouette determinations, while too few rings are not discriminative enough. A value of forty (40) (i.e., 40 rings) has been found to produce good results.

At loop condition checking step 530, if not all of the annuli defined at step 520 have been processed, then the next annulus is selected and processed to determine a feature value in steps 540 to 560. At counting step 540, the number of object pixels, o, within the current annulus are counted. A pixel may be considered to be within an annulus if the distance between the pixel and the object centroid 1151 is greater than the inner radius of the annulus, and less than or equal to the outer radius of the annulus. The number of object pixels, o, within the current annulus, as determined at step 540, may be stored in the memory 1306.

Then at counting step 550, the total number of pixels, t, including object pixels and background pixels, within the current annulus are counted, under execution of the processor 1305. The total number of pixels, t, determined at step 550 may be stored in the memory 1306 under execution of the processor 1305.

At determining step 560, a feature value f is determined by taking the ratio of o to t. The feature value f determined at step 560 may be stored in the memory 1306. The overall effect of steps 540 to 560 is to determine a feature value f for the annulus, whose value is the proportion of annulus pixels which are object pixels. For example, as seen in FIG. 11C, in the area of outer annulus ring 1164, if the combined regions 1171 and 1172 of the annulus containing object pixels is 9% of the area of the whole annulus 1164, then the feature value f for annulus 1164 is 0.09.

After a feature value f has been determined in step 560, the method 500 returns to loop condition checking step 530. If it is determined at step 530 that all of the annuli defined at step 520 have been processed, then the feature extraction method 500 continues at combining step 570. At step 570, all of the values off which were calculated for each annulus are combined into a feature vector. Following step 570, the method 500 concludes.

The method 500 produces a feature vector which, as well as being translationally invariant and scale invariant, is also rotationally invariant. Regardless of how the object is rotated in the 2D plane of the image, the same feature vector will be determined). A rotationally invariant feature vector is necessary when operating together with a two-valued spherical angle pose space as previously described with reference to pose distribution determination step 320 of the method 300.

Because each feature value f is a proportion between zero (0) and one (1), the feature vector produced by the method 500 also has independent and identically distributed (IID) feature values. Independent and identically distributed (IID) is a requirement for good performance of a “ball query” operation as used in step 430 of the method 400. Other features may be extracted which may be used as database keys for the feature database 150 and which are also independent and identically distributed. These other extracted features may encode contour-based, area-based, or other characteristics of the silhouette.

The method 600 of determining a cost score, as invoked at step 260, will now be described with reference to FIG. 6. The method 600 may be implemented by the database query module 160 forming part of the software 1333 resident in the hard disk drive 1310 and being controlled in its execution by the processor 1305. The method 600 is invoked at step 260 of the method 200 for each candidate pose pair in the list. The cost score determination method 600 determines a cost score for a cluster of pose candidate results using a stereo camera constraint.

The method 600 begins at comparing step 610, where candidate poses associated with different ones of the viewpoints are compared under execution of the processor 1305. The candidate poses are compared at step 610 by comparing the object IDs of the left and right candidate poses. If the object IDs are different, a current candidate pair cannot represent a correct estimate, and so the method 600 proceeds to step 620 where a maximal cost is applied under execution of the processor 1305. The maximal cost may be an arbitrarily large numerical value, such as one thousand (1000), or alternatively the maximal cost may be applied by removing the candidate pair from the list of candidate pairs. After a maximal cost is applied in step 620, the method 600 terminates.

If the object IDs of the left and right candidate poses are not different, then the method 600 proceeds from step 610 to determining step 630, where an expected distance from a stereo camera pair to the object being imaged is determined. The distance determined at step 630 may be stored in the memory 1306 under execution of the processor 1305. The stereo camera pair may be a pair of cameras on a mixed-reality or augmented-reality headset. Alternatively, the stereo camera pair may be a pair of cameras on a hand-held device such as a tablet computing device, or may be another pair of cameras. In one arrangement, the cameras are affixed to each other in a fixed relative position and orientation. For simplicity of explanation, the foregoing description assumes cameras pointing in the same (parallel) direction, and separated orthogonally by a known distance. However, other camera arrangements are possible. The expected distance determined at step 630 may be a range of distances, and the range may be narrow or broad. In one arrangement, the expected distance range may be determined based on properties of the image capture device. For example, the minimum distance of the range may be set according to the closest an object can be to the camera while still imaging the entirety of the object in focus. Further, the maximum distance of the range may be set according to the furthest distance at which distinguishing features of the object can be discerned. An example range is 20 cm-90 cm.

Together with a known separation between the stereo cameras, the expected object distance is used at determining step 640 to determine an expected angular distance between the views of the left and right cameras of a given object. The expected angular distance represents an apparent angular separation of the stereo cameras or viewpoints with respect to a given object. The angular distance is the size of the angle between the direction of one camera (e.g., the left camera), and the direction of the other camera (e.g., the right camera), from the viewpoint of the object. The expected angular distance determined at step 640 may be stored in the memory 1306 under execution of the processor 1305. In the example arrangement 800 of FIG. 8A, a 3D printed object 130 is viewed by a pair of stereo cameras 801 and 802. The distance between the cameras c 840 is fixed and known. In the example of FIG. 8A, the distance 820 to the object from the left camera 801 and the distance 830 to the object to the object from the right camera 802 is assumed to be the same distance d. According to the arrangement 800, the angular distance a 810 may be determined as a function of c and d using simple geometry

$$a = 2 arcsin ( \frac{c}{2 d} ) .$$

With a fixed value of c 840 and a range of expected values ford 820 and 830, the angular distance a 810 also takes on a range. For example, if c is 10 cm, and d ranges from 20 cm to 90 cm, then the expected range of a is approximately 6° to 29°.

In determining step 650, the angle difference between the left pose angle and right pose angle of a candidate pair is determined under execution of the processor 1305. The angle difference determined at step 650 may be stored in the memory 1306. The angle difference is the angle of a smallest rotation required to change between a first pose (e.g., a left candidate pose angle from the database) and a second pose (e.g., a right candidate pose angle from the database). Where the pose angles consist of a pair of angles in a spherical co-ordinate system, as previously described with reference to pose distribution determination step 320 of the method 300, the angle difference between the candidate pair is determined under execution of the processor 1305. The determined angle difference may be stored in the memory 1306. A great-circle distance calculation may be used to determine the angle difference at step 650. Examples of a great-circle distance calculation include a direct derivation of the spherical law of cosines, or a variant designed for numerical stability such as the Vincenty formula shown directly below:

$$α = arctan \frac{\sqrt{\begin{matrix}{( cos {ϑ}_{R} \cdot sin ( Δϕ ) )}^{2} + \\ {( cos {ϑ}_{L} \cdot sin {ϑ}_{R} - sin {ϑ}_{L} \cdot cos {ϑ}_{R} \cdot cos ( Δϕ ) )}^{2}\end{matrix}}}{sin {ϑ}_{L} \cdot sin {ϑ}_{R} + cos {ϑ}_{L} \cdot cos {ϑ}_{R} \cdot cos ( Δϕ )}$$

The spherical angle difference σ is determined, using the Vincenty formula above, as the arctangent of a numerator term and a denominator term. The numerator term is the square root of a sum of two squared terms, one being the cosine of the theta angle of the right pose angle multiplied by the sine of the difference in the phi of the left and right pose angles, the other being the cosine of the theta of the left pose angle multiplied by the sine of the theta of the right pose angle, minus the sine of the theta of the left pose angle multiplied by the cosine of the theta of the right pose angle, further multiplied by the cosine of the difference in the phi of the left and right pose angles. The denominator term is a sum of two terms, one being the sines of the theta of each of the left and right pose angles multiplied together, and the other being the cosines of the theta of each of the left and right pose angles multiplied together, further multiplied by the cosine of the difference in the phi of the left and right pose angles. Other numerically stable methods may also be used, such as the haversine formula.

In comparing step 660, the angle difference σ of the left and right candidate poses, as determined in step 650, is compared with the expected angular distance range 810 based on the camera geometry, as determined in step 640. Angular distances based on physical geometry and angle differences of candidate poses from the database may be directly compared. The comparison may be understood by considering a view of an object from an initial viewpoint.

Whether the viewpoint is shifted by an angular distance of a°, or the object is rotated by an angle difference of a°, the same view of the object will result, as long as a common axis and direction of angular motion is used. The same principle dictates that if an angle difference between two pose candidates for an object determined from two cameras viewing the object is a mismatch to the physical angular distance of the two cameras with respect to the object, then one or both candidate poses must be inaccurate. Accordingly, in comparing step 660, if the actual angle difference lies outside the expected angular distance range 810, then in applying step 670, a cost is applied to the candidate pair according to the deviation from the range 810. For example, if an actual angle difference of 90° is determined for an expected angular distance range of 6° to 29°, then a cost score of 61 is applied to the candidate pair. The cost may be scaled by a pre-determined constant factor to balance the weight of the cost relative to other possible cost factors. Independent cost factors arising from other constraints may be applied additively to the same candidate pair. After the cost is applied to the candidate pair in step 670, or if the angle difference was within the expected angular distance range in step 660, the method 600 terminates.

The method 700 of determining an object ID and pose, as invoked at step 270, will now be described with reference to FIG. 7. The method 700 uses the clustered, costed query results produced by steps 230, 240, 250, and 260 of method 200, to decide an estimated object ID and pose of a 3D printed object 130 in a camera image. The method 700 may be implemented by the database query module 160 forming part of the software 1333 resident in the hard disk drive 1310 and being controlled in its execution by the processor 1305.

The method 700 begins at selecting step 710, where the cluster pair having the lowest cost is selected as the left and right candidates having the highest confidence of being a good estimate of the true pose. The selected cluster pair may be stored in the memory 1306. In selecting step 720, a pose for each of the left and right cluster is determined under execution of the processor 1305. In order to produce an estimated pose matching a pose which exists in the feature database, a most representative member of the cluster is selected. The most representative member of the cluster is the member amongst the members of the cluster whose angle values are closest to the average of the cluster.

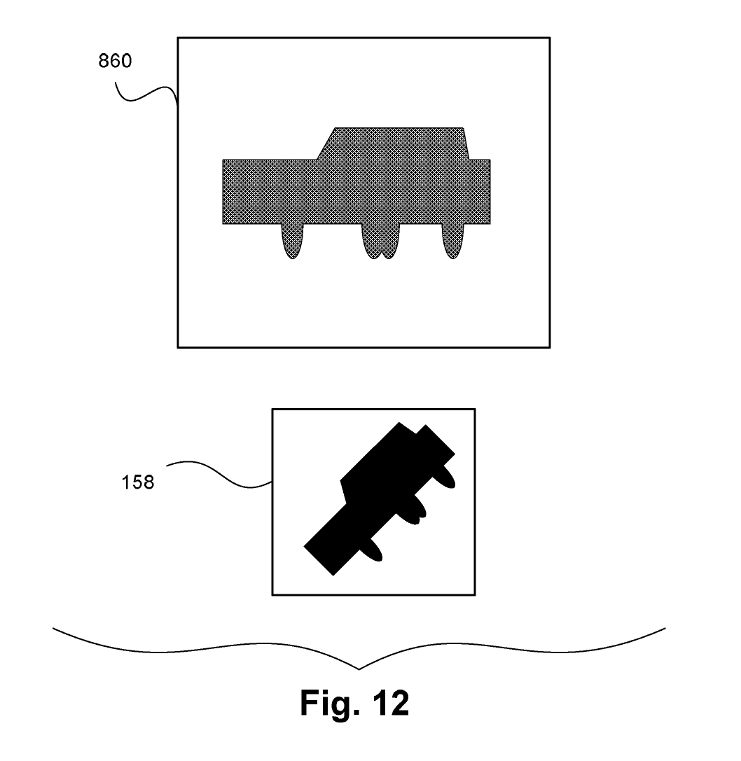

In determining step 730, a pose estimate in the frame of reference of each camera is determined, under execution of the processor 1305. The determined pose estimates may be stored in the memory 1306. Because the pose space is a two-valued angle space and the feature is a rotation-invariant feature, the poses determined at step 730 are limited to a two-angled pose. In step 730, the rotation of the object in the image plane is determined in a 2D rotation matching operation which identifies the best matching 2D rotation of the imaged silhouette 860, with respect to the silhouette 158 of the selected pose entry 152 in the feature database 150. Any suitable method may be used to perform the 2D rotation matching, including a brute force method which maximises the overlap of the silhouettes, after normalisation to the same scale and centroid position. Alternatively, principal component analysis (PCA) or a similar method may be used to identify a principal orientation of each of the imaged silhouette 860 and the silhouette 158 of the selected pose entry 152. The 2D rotation angle may be determined as the absolute angle difference between the principal orientations. In the example of FIG. 12, the image silhouette 860 is matched to the database silhouette 158 by a rotation of 45°, even though the two silhouettes 860 and 158 may be at different scales and positions in the respective images.

In unifying step 740, the frame of reference of the pose of the object is unified from the two camera frames of reference to a single co-ordinate space. A unified camera frame of reference may be defined as equal to one of the cameras, or to the midpoint between the cameras, or some other fixed position relative to the cameras. The poses may be unified at step 740 by averaging the pose estimate for each camera image after transformation to the camera frame of reference.

Alternatively, the poses may be unified at step 740 by selecting the pose which was determined with greatest confidence after transformation to the camera frame of reference. Unifying the poses by selecting the pose which was determined with greatest confidence after transformation to the camera frame of reference is beneficial in the unusual case where the best candidate pair has poses with different object IDs for the left and right cluster. Depending on the application, various further frames of reference may be used. For rendering virtual content which overlays the 3D printed object 130, the pose may be transformed from the camera frame of reference to a world reference frame, a display reference frame, or some other frame of reference, using standard affine transform techniques.

In determining step 750, the object ID is estimated using the selected cluster pair, under execution of the processor 1305. Generally, the object ID of the left cluster and the right cluster for the lowest cost candidate pair will be the same, because candidate pairs having different object IDs for the left and right cluster have been given a maximal cost in step 620. If the object IDs are the same, then the common object ID of the pair is used as the estimated object ID for the current estimation task. In the case that the left and right object IDs are different, the ID of the pose which was determined with greatest confidence is used at step 750. The object ID determined at step 750 may be stored in the memory 1306, under execution of the processor 1305.

In determining step 760, an overall confidence of the match is determined under execution of the processor 1305. The confidence can be determined at step 760 from the cost of the selected (lowest cost) cluster pair, or from the number of non-overlapping pixels in a 2D rotation matching step when unifying the frame of reference in step 740. The confidence output at step 760 may be used in an augmented reality application. For example, if the confidence determined at step 760 is below a threshold, then the virtual content may not be updated to reflect the new position estimate, but may continue to be displayed at a previously determined pose. The method 700 then terminates following step 760.

In another arrangement, at step 320 a three-valued 3D angle space, such as a sampling of the rotation group SO(3), is determined rather than a two-valued spherical angle space. Similarly to the two-valued angle case, the distribution determined at step 320 for a three-valued 3D angle space may aim for uniformity, or may be adaptive with respect to the shape. Any suitable method for generating a sampling of the rotation group SO(3) may be used at step 320, including use of the Hopf Fibration. Since a pose space of three dimensions is sampled rather than two, a significantly greater number of poses is required to get the same degree of coverage.

Additionally, in an arrangement which samples a 3D pose space the feature extraction method 500 is modified to produce features which are not rotationally invariant. In step 570, an additional feature encoding the orientation of the principal axis of the silhouette is included in the feature vector.

A further modification of object ID and pose determination method 700 in the arrangement which samples a 3D pose space is described with reference to FIG. 10B. Rather than a two-valued pose angle 157 of database entry 152 as used in FIG. 10A, a three-valued pose angle 159 of database entry 152 in FIG. 10B is present. Because all three angles in the 3D pose angle are present in the lowest-cost cluster selected in step 710 of object ID and pose determination method 700, step 730 of the method 700 does not include a 2D rotation matching step. Additionally, a database entry 152 for a three-valued angle space as shown in FIG. 10B need not contain a silhouette image 158 which a two-valued spherical angle space database entry 152 of FIG. 10A contains, because the purpose of the silhouette image 158 is to act as a reference for the 2D rotation matching operation in step 730 of method 700.

Additional processing may be performed to obtain a narrower range for the expected distance to the object in distance estimation step 630 of the method 600.

In one arrangement, stereo disparity is applied to left and right stereo images to estimate a depth to the object. Although stereo disparity is unreliable for generating a rich depth map due to the textureless nature of the surface of the 3D printed object 130, stereo disparity may be used at object edges for a rough overall estimate of the depth. The depth estimate may then be used as the distance d 820 and 830 as shown in FIG. 8.

In a further arrangement, the apparent scales of the object in the left and right images are analysed separately to determine a separate left distance estimate 820 and right distance estimate 830. For a left pose candidate in a candidate pair, a scale factor Sᵣ may be determined based on the distance between the object pixel centroid and the most distant pixel of the rendered silhouette image 158, normalised according to the virtual camera parameters used to render the silhouette. The virtual camera distance Dᵣ at which the object was rendered may be captured at render time, stored as part of the database entry 152, and also retrieved during step 630.

The captured left silhouette image 860 may similarly be characterised by a scale factor S_{c}, normalised according to the physical camera parameters used to capture the image. For the left silhouette image 860, the distance D_{c} from the object to the physical camera is unknown. However, if the rendered silhouette image 158 and the camera image 860 are indeed of the same object at the same pose, then the proportional relation

$$\frac{{S}_{r}}{{S}_{c}} = \frac{{D}_{r}}{{D}_{c}}$$

will hold, providing an estimate of the left camera distance D_{c}(L) 820 as the ratio of the camera image scale S_{c} to the rendered image scale factor Sᵣ, multiplied by the virtual camera distance Dᵣ:

$${D}_{c} ( L ) = \frac{{S}_{c}}{{S}_{r}} \cdot {D}_{r} .$$

The same process described directly above for the captured left silhouette image 860 may be applied using the rendered silhouette image 158 of the database entry 152 corresponding to the right pose candidate in the candidate pair and the captured right silhouette image 861 to determine a second estimate of the camera distance D_{c}(R) 830 for the right camera.

As such, if the mesh is rendered at a greater virtual camera distance than the physical camera distance, then the rendered silhouette image 158 is smaller than the silhouette in the captured image. Similarly, if a physical 3D printed object 130 is imaged at a greater physical camera distance, then the apparent size of the object in the captured image is smaller.

In a stereo camera rig configuration, where the left and right cameras are pointing in the same (parallel) direction, and separated orthogonally by a short distance, the average Dₐ of D_{c}(L) 820 and D_{c}(R) 830 is used in 630. The estimated distance Dₐ may be expanded into a range around Dₐ according to the precision of the measurements involved.

Further, the difference between D_{c}(L) and D_{c}(R) provides additional input which may form a further stereo-based cost score factor. In the case of a stereo camera rig configuration where the actual left and right camera distances to the object are similar, the estimated object distance values D_{c}(L) and D_{c}(R) will be similar to each other for an accurate candidate pair, and so an additional cost score may be imposed according to the absolute difference of D_{c}(L) and D_{c}(R). In general, for other non-orthogonal camera configurations, a constraint relationship between D_{c}(L) and D_{c}(R) may also be determined. For example, with two cameras facing each other two meters apart, viewing an object between the two cameras, the distance values D_{c}(L) and D_{c}(R) will sum to two meter when determined for a correct candidate left and right pose pair. So the additional cost score may be incurred according to the absolute value of 2−D_{c}(L)−D_{c}(RR).

In another arrangement, additional cost factors are incurred on candidate cluster pairs during the cost score determination method 600 of FIG. 6.

A first additional cost factor exploits the expectation that the pose of an object from frame to frame of an image stream, as iterated over in loop condition checking step 220 of the method 200, will not change greatly. In the arrangement where a first additional cost factor is determined, a confidence of the pose estimate of the previous frame, as determined in step 760, is compared to a threshold. If the confidence of the previous pose estimate is high (i.e., above the threshold), then the angle difference between the current candidate cluster and the previous pose is computed. A separate angle difference may be determined for each of the left and right poses. In each case, an additional cost may be applied based on the magnitude of the angle difference. The cost may be equal to the angle difference, scaled by a pre-determined constant factor to balance a weight of the cost relative to other cost factors. In this way, candidate poses which differ from a high-confidence pose determination of the previous frame are given a high cost and are therefore less likely to be selected as the pose estimate.

A second additional cost factor exploits the tendency for a high-dimensional ball query lookup as per step 430 to produce more results in the vicinity of the true pose than elsewhere. A consequence of the more results is that the size (i.e., number of entries) of the cluster containing the true pose is likely to be larger than the size of other clusters. Additionally, query results which would not be obtained by an exact ball query but which are obtained by an approximate ball query tend to be outliers. An additional cost is incurred based on the size of the left and right candidate clusters. The additional cost is smaller for a cluster with larger size. For example, the additional cost may be the negative of the cluster size, scaled by a pre-determined constant factor to balance a weight of the additional cost relative to other cost factors. In this way, clusters less likely to represent the true pose, including outliers from an approximate ball query, are given a higher cost, making such candidate clusters less likely to be selected as the pose estimate.

As previously described, each cost factor may be scaled by a pre-determined constant factor to balance a weight relative to other possible cost factors. For example, the stereo angle difference cost factor determined in step 670 may be one (1.0). The first additional cost factor based on inter-frame tracking may also be one (1.0), and the second additional cost factor based on cluster size may be 5.0. With these additional cost factors, a maximal cost incurred due to smallness of cluster size would be equivalent to an angle deviation from the expected range of 5°, and also equivalent to an angle change from the pose estimate of the previous frame of 5°.

By accounting for the tracking constraint and the clustering constraint and applying corresponding additional cost factors as described, the accuracy of the described methods may be improved.

The methods described above may also be used to provide pose estimates for machine vision systems, for use in an industrial setting. In a further arrangement, cameras may be set up around a robotic station at which 3D printed objects 130 or other objects are processed by robotically controlled tools. In such a scenario, the cameras may be placed in any arrangement, and more than two cameras may be used. For example, four cameras may be used from various different viewpoints around the robotic station. The relative position and orientation of each camera may be determined with respect to the other cameras by an initial calibration step.

During the operation of the method 200, step 230 and 240, which perform separate database queries for the left and right cameras, may be repeated for each camera in a system such as the machine vision system with the cameras set up around the robotic station as described above. For the arrangement with the cameras set up around the robotic station, step 250 iterates not over candidate pairs, but candidate tuples, considering each combination of candidate results from lookup results of each camera. The method 700, invoked at step 270, may select in step 710 not a candidate pair but a candidate tuple, and step 730 may produce pose estimates for each camera frame of reference.

For the arrangement with the cameras set up around the robotic station, step 740 unifies the pose estimates from each of the camera viewpoints to a single frame of reference. The pose estimates are unified by combining one or more pose estimates from the cameras in a determined frame of reference, such as a selected camera frame of reference, the workspace frame of reference, or machine tool frame of reference. The robot may be controlled to perform an operation on the basis of the object pose, whether that operation is picking up a part and placing the part in a known orientation, or performing a machining operation on the part.

The operation of the methods described above will be further described by way of example with reference to FIG. 8B and FIG. 9B. In the example of FIG. 8B and FIG. 9B, database query step 230 of the method 200 invokes method 400, in which the silhouette 860 of the left image 850 is determined in step 410. The silhouette features of the silhouette 860 are determined in step 420, and a database lookup using the computed features as a key is performed in step 430. In step 440, the database query results may be clustered, resulting in a set 930 of three candidate pose clusters for the left image.

Database query step 240 of the method 200 similarly invokes database query method 400, in which the silhouette 851 of the right image 861 is determined in step 410. The silhouette features of the silhouette 851 are determined in step 420, and a database lookup using the determined features as a key is performed in step 430. In step 440, the database query results may be clustered, resulting in a set 940 of two candidate pose clusters for the right image.

In the example of FIG. 8B and FIG. 9B, step 250 and 260 invoke the method 600 for each pair of candidates 951, 952, 953, 954, 955, and 956 in turn, to apply a cost to each candidate pair. The candidate pairs 951-956 are formed by each combination of left image pose clusters 930 and right image pose clusters 940. In step 610, the object IDs of candidate pair 951 are compared, and are found to be different: left cluster L1 has an object ID of four (4), while right cluster R1 has an object ID of one (1). Step 610 therefore proceeds to step 620, in which a maximal cost is applied to candidate cluster pair 951. Similarly, the object IDs of the left and right clusters in each of the candidate cluster pairs 952 and 953 are different, and so step 620 also assigns a maximal cost to the candidate pairs cluster pairs 952 and 953.

Continuing the example of FIG. 8B and FIG. 9B, step 610 is next invoked for candidate cluster pair 954. In the candidate pair 954, both the left cluster L1 and right cluster R2 have an object ID of four (4), and so step 610 proceeds to estimation step 630. Step 630 estimates a distance range of 20 cm-90 cm as previously described, resulting in an expected angular distance range at step 640 of 6° to 29°. Step 650 calculates the actual angle difference for the candidate pair 954, by determining the spherical angle distance between the average pose angle of the left cluster members (30°, 51°) and the average pose angle of the right cluster members (72°, 15°), whose value is found to be 41°. In decision step 660, the angle difference is determined to be outside of the expected angular distance range of 6° to 29°, and so the method 600 proceeds to costing step 670. The distance of the difference angle from the expected angular distance range is 41°−29°=12°, so a cost of twelve (12) is applied in step 670, and the method 600 returns to inner loop condition check 250 of method 200.

In the example of FIG. 8B and FIG. 9B, the method 600 is next invoked from step 260 for candidate cluster pair 955. The 600 proceeds as before, at step 640 calculates an angle difference between the left average pose (200°, 70°) and the right average pose (72°, 15°) of 80°. The distance of the difference angle from the expected angular distance range is 80°−29°=51°, so a cost of fifty one (51) is applied in step 670. The method 600 is invoked once more for candidate cluster pair 955, for which step 640 determines an angle difference between the left average pose (55°, 20°) and the right average pose (72°, 15°) of 7°. At step 660, the angle difference of 7° is determined to lie within the expected angular distance range of 6° to 29°, and so the method 600 returns to method 200 without applying a cost to candidate cluster pair 956. That is, the cost of candidate cluster pair 956 remains at zero.

Continuing the example of FIG. 8B and FIG. 9B, step 250 of the method 200 finds no more candidate pairs to cost, so the method 200 proceeds to step 270, invoking object ID and pose determination method 700. Step 710 selects candidate cluster pair 956, because the cost of the pair 956 being zero is the lowest of all six candidates. In step 720, a representative left cluster member whose pose is closest to the average cluster pose of (55°, 20°) is selected, and a representative right cluster member whose pose is closest to the average cluster pose of (72°, 15°) is selected. In step 730, the selected members undergo 2D rotation matching step to determine a rho angle, completing the 3D pose estimation in the camera frames of reference. As shown in FIG. 12, left image silhouette 860 is rotated by 45° to match the database silhouette 158 of the database entry 152 corresponding to the left representative cluster member. Step 740 unifies the frame of reference, in the example choosing the left camera frame of reference, and step 750 selects the estimated object ID of four (4), which is common to the left and right clusters of the selected pair 956. In the example of FIGS. 8B and 9B, a high confidence is set in step 760, because the result of rotating the normalised left image silhouette 860 by the selected 2D rotation angle of 45° and overlaying onto the normalised database silhouette 158 in 2D rotation matching step 730 produced few non-overlapping pixels.

By means of the described methods, the 3D printed objects 130 may be composed with virtual 3D content which is rendered at substantially the same pose as the object 130. Many useful types of virtual content are possible. The types of virtual content include an augmented surface appearance, for purposes including design evaluation, visualisation, or marketing; and overlaid information, for purposes including workflow integration, or error or diagnostics reporting. This composition of virtual content is achieved automatically, without requiring complicated setup or attaching markers to objects in the scene, making operation simple even for untrained users. This composition of virtual content is also achieved without the need for a dense depth image, reducing the cost and complexity of the hardware used by the described methods.

### INDUSTRIAL APPLICABILITY

The arrangements described are applicable to the computer and data processing industries and particularly for image processing.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A method of determining a pose for an object, the method comprising:
receiving a plurality of images capturing the object at different viewpoints, the viewpoints being related by an angular distance with respect to the object;
extracting a feature vector for the object from each of the received images;
comparing each extracted feature vector with feature vectors from a database to determine a plurality of candidate poses; and
determining a pose of the object by comparing candidate poses associated with different ones of the viewpoints, using the angular distance between the viewpoints with respect to the object.

2. The method according to claim 1, wherein the angular distance between the viewpoints from the object is determined according to relative poses of the viewpoints and a determined distance between the viewpoints and the object.

3. The method according to claim 2, wherein the distance between the viewpoints and the object is determined based on properties of an image capture device.

4. The method according to claim 2, wherein the distance between the viewpoints and the object is determined using apparent size of the object in the plurality of images.

5. The method according to claim 1, further comprising composing virtual 3D content with at least one image of the object using the determined pose.

6. The method according to claim 1, wherein the database comprises a plurality of feature vectors of the object, each of the feature vectors in the database being associated with one of a plurality of poses.

7. The method according to claim 1, wherein the feature vector for the object represents a list of proportions coverage of pixels of the object within annulus rings.

8. The method according to claim 1, further comprising:
matching the extracted feature vector with feature vectors in the database; and
selecting a plurality of matched feature vectors based on a match score.

9. The method according to claim 1, further comprising:
clustering the plurality of candidate poses;
determining a cost score for each cluster;
selecting one of the clusters with the lowest cost score; and
determining the pose using a representative pose of the selected cluster.

10. The method according to claim 9, wherein the cost score determined for each cluster is based on a deviation between a pose associated with the cluster and a pose associated with a reference cluster in respect to the angular distance, the reference cluster being associated with a second viewpoint from a pair of viewpoints related by the angular distance.

11. The method according to claim 9, wherein the cost score determined for each cluster is based on a deviation of a pose associated with said cluster from a pose determined for a previous frame.

12. The method according to claim 9, wherein the cost score determined for each cluster is based on a number of members of the cluster.

13. The method according to claim 1, wherein pose angles associated with the candidate poses are two-valued angle co-ordinates.

14. The method according to claim 1, wherein pose angles associated with the candidate poses are three-valued angle co-ordinates.

15. An apparatus for determining a pose for an object, the apparatus comprising:
means for receiving a plurality of images capturing the object at different viewpoints, the viewpoints being related by an angular distance with respect to the object;
means for extracting a feature vector for the object from each of the received images;
means for comparing each extracted feature vector with feature vectors from a database to determine a plurality of candidate poses; and
means for determining a pose of the object by comparing respective candidate poses associated with different ones of the viewpoints, using the angular distance between the viewpoints with respect to the object.

16. A system for determining a pose for an object, the system comprising:
a memory for storing data and a computer program;
a processor coupled to the memory for executing the program, the program comprising instructions for:
receiving a plurality of images capturing the object at different viewpoints, the viewpoints being related by an angular distance with respect to the object;
extracting a feature vector for the object from each of the received images;
comparing each extracted feature vector with feature vectors from a database to determine a plurality of candidate poses; and
determining a pose of the object by comparing respective candidate poses associated with different ones of the viewpoints, using the angular distance between the viewpoints with respect to the object.

17. A computer readable medium having a program stored on the medium for determining a pose for an object, the program comprising:
code for receiving a plurality of images capturing the object at different viewpoints, the viewpoints being related by an angular distance with respect to the object;
code for extracting a feature vector for the object from each of the received images;
code for comparing each extracted feature vector with feature vectors from a database to determine a plurality of candidate poses; and
code for determining a pose of the object by comparing respective candidate poses associated with different ones of the viewpoints, using the angular distance between the viewpoints with respect to the object.
